(19) United States
(12) Patent Application Publication
(10) Pub. No.: US 2021/0281691 A1
(43) Pub. Date: Sep. 9, 2021

(54) DISPLAY DEVICE AND NON-TRANSITORY COMPUTER-READABLE STORAGE MEDIUM STORING PROGRAM

(71) Applicant: SEIKO EPSON CORPORATION, Tokyo (JP)

(72) Inventor: Hiroyuki TOKUNAGA, Matsumoto (JP)

(21) Appl. No.: 17/187,908

(22) Filed: Mar. 1, 2021

(30) Foreign Application Priority Data
Mar. 3, 2020 (JP) 2020-036203

(51) Int. Cl. H04N 1/00

(52) U.S. Cl. CPC H04N 1/00469; H04N 1/00411; H04N 2201/0094; H04N 1/00506; H04N 1/00413

(57) ABSTRACT

A display device for displaying a plurality of images side by side in the X-direction on a touch panel, the display device including a reception section configured to receive specification of a display magnification of the images; and a display controller configured to display the images on the touch panel, wherein the display controller changes the aspect ratio of the images in accordance with the display magnification.

The present application is based on, and claims priority from JP Application Serial Number 2020-036203, filed Mar. 3, 2020, the disclosure of which is hereby incorporated by reference herein in its entirety.

### BACKGROUND

### 1. Technical Field

The present disclosure relates to a display device and a non-transitory computer-readable storage medium storing a program.

### 2. Related Art

JP-A-2004-328265 discloses a display device that displays a plurality of images such that the images are disposed diagonally in the depth direction of a screen.

Further improvements in the method of displaying images have been demanded.

### SUMMARY

According to an aspect of the present disclosure, there is provided a display device for displaying an image on a screen, the display device including: a reception section configured to receive specification of a display magnification of the image; and a display controller configured to display the image on the screen, wherein assuming that a length of the image in a first direction of the screen is Y, and a length of the image in a second direction intersecting the first direction is X, the display controller changes a length ratio being X/Y in accordance with the display magnification.

According to another aspect of the present disclosure, there is provided a non-transitory computer-readable storage medium storing a program for causing a display device to perform processing to display an image on a screen, the processing including: a receiving step of receiving specification of a display magnification of the image; and a display controlling step of displaying the image on the screen, wherein in the display controlling step, assuming that a length of the image in a first direction of the screen is Y, and a length of the image in a second direction intersecting the first direction is X, a length ratio being X/Y is changed in accordance with the display magnification.

According to still another aspect of the present disclosure, there is provided a display device for displaying an image on a screen, the display device including: a reception section configured to receive specification of a display magnification of the image; and a display controller configured to display the image in an inclined manner at a predetermined inclination rate with respect to the screen, wherein the display controller changes the inclination rate in accordance with the display magnification.

According to still another aspect of the present disclosure, there is provided a non-transitory computer-readable storage medium storing a program for causing a display device to perform processing to display an image on a screen, the processing including: a receiving step of receiving specification of a display magnification of the image; and a display controlling step of displaying the image in an inclined manner at a predetermined inclination rate with respect to the screen, wherein in the display controlling step, the inclination rate is changed in accordance with the display magnification.

### BRIEF DESCRIPTION OF THE DRAWINGS

FIG. 1 is a system configuration diagram of a communication system.

FIG. 2 is a block diagram illustrating the hardware configuration of a user terminal.

FIG. 3 is a block diagram illustrating the functional configuration of the user terminal.

FIG. 4 is a diagram illustrating a display example of a menu selection screen.

FIG. 5 is an explanatory diagram of an upright image and an inclined image.

FIG. 6 is an explanatory diagram of a length ratio of the inclined image.

FIG. 7 is a diagram illustrating a display example of the menu selection screen when an image is selected.

FIG. 8 is a diagram illustrating a display example of the menu selection screen, which is continued from FIG. 7.

FIG. 9 is a diagram illustrating a display example of the menu selection screen, which is continued from FIG. 8.

FIG. 10 is a flowchart illustrating the flow of display magnification change processing according to a first embodiment.

FIG. 11 is a graph illustrating the relationship between the size of an image and the length ratio of the image according to the first embodiment.

FIG. 12 is a diagram illustrating a display example of the menu selection screen according to the first embodiment.

FIG. 13 is a diagram illustrating a display example of the menu selection screen when an operation to increase the display magnification is performed from the state illustrated in FIG. 12.

FIG. 14 is a diagram illustrating a display example of the menu selection screen when an operation to increase the display magnification is performed from the state illustrated in FIG. 13.

FIG. 15 is a flowchart illustrating the flow of the display magnification change processing according to a second embodiment.

FIG. 16 is a graph illustrating the relationship between the size of an image and the length ratio of the image according to the second embodiment.

FIG. 17 is a diagram illustrating a display example of the menu selection screen according to the second embodiment.

FIG. 18 is a diagram illustrating a display example of the menu selection screen when an operation to increase the display magnification is performed from the state illustrated in FIG. 17.

FIG. 19 is a diagram illustrating a display example of the menu selection screen when an operation to increase the display magnification is performed from the state illustrated in FIG. 18.

FIG. 20 is a graph illustrating the relationship between the size of an image and the length ratio of the image according to a variation 2.1.

FIG. 21 is a graph illustrating the relationship between the size of an image and the length ratio of the image according to a variation 2.2.

FIG. 22 is a graph illustrating the relationship between the size of images and the interval ratio of the images according to a variation 2.3.

FIG. 23 is a diagram illustrating a display example of the menu selection screen according to the variation 2.3.

FIG. 24 is a diagram illustrating a display example of the menu selection screen when an operation to increase the display magnification is performed from the state illustrated in FIG. 23.

FIG. 25 is a diagram illustrating a display example of the menu selection screen when an operation to increase the display magnification is performed from the state illustrated in FIG. 24.

FIG. 26 is a diagram illustrating an example of an image according to a variation 3.1.

### DESCRIPTION OF EXEMPLARY EMBODIMENTS

### First Embodiment

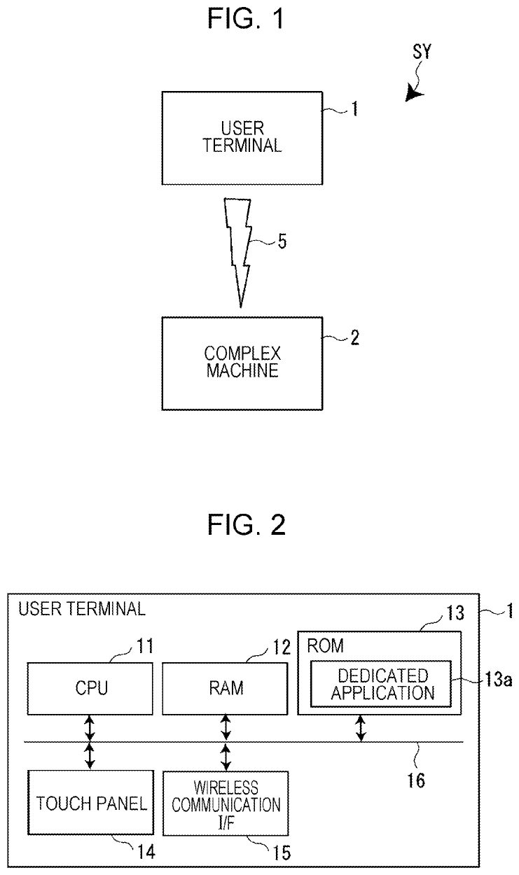

In the following, a description will be given of a display device according to an embodiment and a program with reference to the accompanying drawings. FIG. 1 is a system configuration diagram of a communication system SY to which the display device and the program are applied.

The communication system SY includes a user terminal 1 and a complex machine 2. The user terminal 1 is an example of the “display device”. The user terminal 1 and the complex machine 2 are connected via wireless communication 5. In this regard, the user terminal 1 and the complex machine 2 may be connected via wired communication.

The user terminal 1 is a terminal for controlling the complex machine 2. In the present embodiment, a smartphone is assumed as the user terminal 1. However, a PC (personal computer) or a tablet terminal may be used.

The complex machine 2 is an electronic device having a print function, a copy machine function, a scan function, a FAX function, and the like. A user gives various instructions, such as a print instruction, a copy instruction, a scan instruction, a FAX transmission instruction, and the like to the complex machine 2 by using the user terminal 1. Also, the user performs various settings regarding various functions of the complex machine 2 by using the user terminal 1.

Next, a description will be given of the hardware configuration of the user terminal 1 with reference to FIG. 2. The user terminal 1 includes a CPU (central processing unit) 11, a RAM (random access memory) 12, a ROM (read only memory) 13, a touch panel 14, and a wireless communication interface 15 as the hardware configuration, and these components are coupled via a bus 16. The touch panel 14 is an example of the “screen”.

The CPU 11 loads the various programs stored in the ROM 13 into the RAM 12 so as to control each section of the user terminal 1. In this regard, as a processor in place of the CPU 11, a hardware circuit, such as an ASIC (application specific integrated circuit), or the like may be used. Also, the processor may have a configuration in which one or more CPUs and a hardware circuit, such as an ASIC, or the like operate in combination with each other.

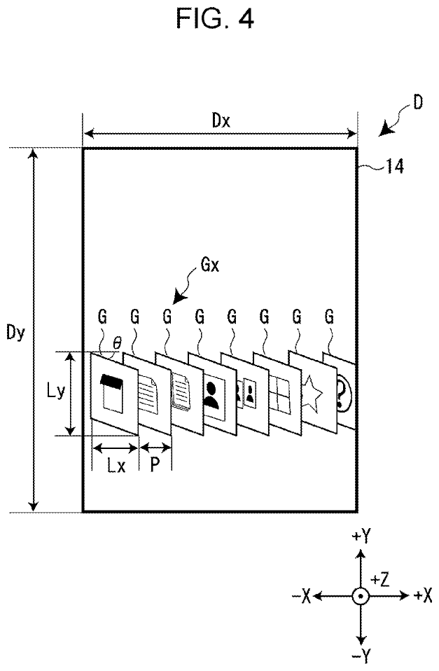

The ROM 13 stores a dedicated application 13a. The dedicated application 13a is an example of the “program”. The dedicated application 13a is an application program that issues various instructions to the complex machine 2 and performs various settings regarding the complex machine 2. The CPU 11 performs display control of a menu selection screen D illustrated in FIG. 4, and the like based on the dedicated application 13a. The menu selection screen D is a screen for selecting a menu of the various operations regarding the complex machine 2.

The touch panel 14 is an electronic component produced by combining a display screen, such as a liquid crystal panel, or the like and a position input device, such as a touchpad, or the like. The touch panel 14 is used to display the menu selection screen D and for a user to perform various operations on the menu selection screen D. In this regard, it is assumed that the touch panel 14 according to the present embodiment is operated by a finger of the user, but may be operated by using an operation tool.

The wireless communication interface 15 performs communication with the complex machine 2 via the wireless communication 5.

Next, a description will be given of the functional configuration of the user terminal 1 with reference to FIG. 2. The user terminal 1 includes a reception section 110 and a display controller 120 as the functional configuration. These functions are realized by the CPU 11 executing the dedicated application 13a.

The reception section 110 receives an instruction of the display magnification of the image G from the user. This process is an example of the “receiving step”. The display magnification of the image G refers to a display magnification of information displayed on the touch panel 14. Accordingly, when the display magnification of the image G is changed, the display magnification of the menu selection screen D displayed on the touch panel 14 is also changed. That is to say, it is possible to regard that specification of the display magnification of the image G is specification of the display magnification of the touch panel 14. In this regard, it is assumed that the display magnification is specified at the same magnification in the X-direction and the Y-direction.

Also, the reception section 110 receives specification of the display magnification in a plurality of stages from the user. The specification of the display magnification may be performed by the user directly specifying a numeric value. Also, the specification of the display magnification may be performed by the user specifying relatively, for example the user increasing the current display magnification, or the user specifying indirectly by specification of the display size of the image G. Also, when a certain time period elapses without the user scrolling the image G, it is possible to estimate that the user wants to closely observe the image G. Accordingly, it may be determined that an implicit instruction is given to increase the display magnification in such a case.

The reception section 110 according to the present embodiment receives specification of gradually changing the display magnification so as to smoothly expand or shrink the information displayed on the touch panel 14. The specification of gradually changing the display magnification refers to, for example, pinch in or pinch out on the touch panel 14. In this regard, “pinch in” is an operation for pinching with two fingers so as to narrow the interval. Also, “pinch out” is an operation for widening two fingers so as to widen the interval.

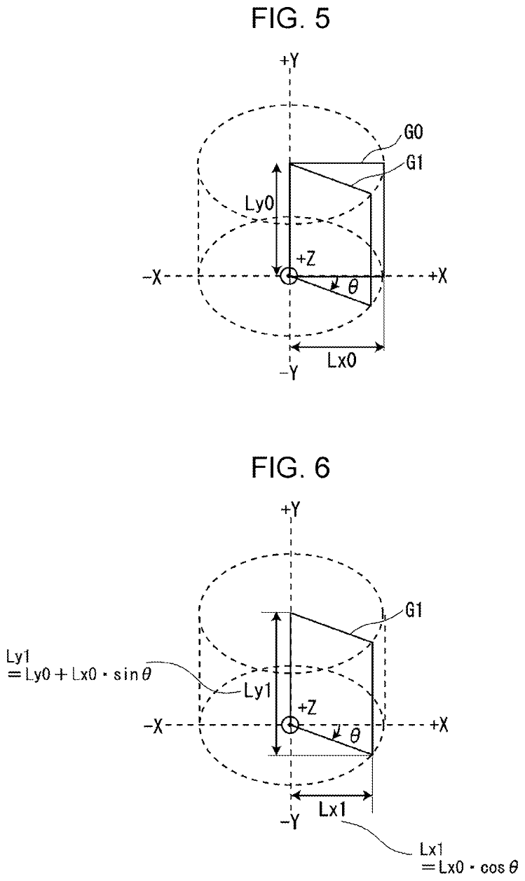

The display controller 120 displays a plurality of images G at the display magnification specified by the reception section 110 on the touch panel 14 (refer to FIG. 4). In the present embodiment, the images G refer to panel-shaped icons representing a menu of operations regarding the complex machine 2. In this regard, in FIG. 4, the left direction is designated as −X-direction, the right direction is designated as +X-direction, the up direction is designated as +Y-direction, the down direction is designated as −Y-direction, the front side of the touch panel 14 is designated as +Z-direction, and the back side of the touch panel 14 is designated as −Z-direction. These notations are the same as in FIGS. 5 to 9, FIGS. 12 to 14, FIGS. 17 to 19, and FIGS. 23 to 26.

Also, the display controller 120 changes the length ratio, which is the ratio of the length of a plurality of images G in the X-direction to the length in the Y-direction, in accordance with the specification of the display magnification received by the reception section 110. This process is an example of the “display controlling step”. The Y-direction is an example of the “first direction”. Also, the X-direction is an example of the “second direction”. In this regard, the X-direction ought to intersect the Y-direction, and does not have to be perpendicular to the Y-direction.

More Specifically, as illustrated in FIG. 4, and the like, the display controller 120 displays a plurality of images G side by side in the X-direction. Compared with the length ratio when a first display magnification of the plurality of images G is specified, the display controller 120 increases the length ratio when a second display magnification, which is higher than the first display magnification, is specified. Also, the display controller 120 displays a plurality of images G on the touch panel 14 so as to have a different length ratio in accordance with a specified stage of the display magnification received by the reception section 110.

In this regard, the display controller 120 according to the present embodiment determines the size of the images G in accordance with the specification of the display magnification received by the reception section 110, and determines the length ratio of the images G in accordance with the size of the images G. The size of the images G refers to, for example, the length in the Y-direction of the images G. In this regard, as the size of the images G, the length in the X-direction of the images G or the area of the images G may be used instead of the length in the Y-direction size.

Also, when the size of the images G is smaller than or equal to a first size threshold value, the display controller 120 according to the present embodiment displays the images G at a first length ratio, and when the size of the images G is larger than the first size threshold value, the display controller 120 displays the images G at the maximum length ratio. The maximum length ratio refers to the maximum value of the length ratio. Also, the first length ratio refers to a predetermined ratio that is lower than the maximum length ratio and higher than the minimum length ratio. The minimum length ratio refers to the minimum value of the length ratio.

Also, the display controller 120 according to present embodiment keeps the interval ratio of images G constant regardless of the specification of the display magnification received by the reception section 110. The interval ratio of the images G refers to the ratio of the disposition interval of the two adjacent images G to the length in the X-direction of any ones of the images G out of the plurality of images G. When two adjacent images G are a first image G and a second image G, the disposition interval refers to the interval in the X-direction between one end in the X-direction of the first image G and one end in the X-direction of the second image G. In this regard, in the present embodiment, a plurality of images G displayed on the menu selection screen D have all the same shape and the same size, and the disposition intervals in the X-direction are the same. Accordingly, a plurality of images G have a constant disposition interval, and thus the interval ratio becomes constant.

Next, a description will be given of the menu selection screen D with reference to FIG. 4. As illustrated in FIG. 4, the menu selection screen D is displayed on the entire display screen of the touch panel 14. Here, the length in the X-direction of the menu selection screen D is “Dx”, and the length in Y-direction of the menu selection screen D is “Dy”.

Also, a plurality of images G are displayed side by side in line in the X-direction on the menu selection screen D. Here, the length in the X-direction of the image G is “Lx”, and the length in the Y-direction of the image G is “Ly”. Also, the length ratio of the image G is the ratio of the length in the X-direction of the image G to the length in the Y-direction, and thus the length ratio becomes “Lx/Ly”. In this regard, Lx is an example of “X”, Ly is an example of “Y”, and Lx/Ly is an example of “X/Y”.

Also, a plurality of images G are disposed at regular intervals in the X-direction on the menu selection screen D. The disposition interval of the plurality of images G is “P”. In the example in FIG. 4, “P<Lx”. That is to say, in the example in FIG. 4, the plurality of images G are displayed in a partially overlapped state in the X-direction. Also, in the example in FIG. 4, the plurality of images G are displayed in the state so as to be viewed as in an inclined state with respect to the display screen of the touch panel 14. In this disclosure, the state in which the images are viewed as in an inclined state with respect to the display screen of the touch panel 14 in this manner is sometimes referred to simply as an inclined state. In this regard, a description will be given later of the inclination of the images G and the length ratio of the images G in the inclined state.

Also, symbols indicating respective menus are displayed on the corresponding faces in the −X-direction of the plurality of images G. Each of the plurality of images G is associated with a corresponding one of a scan function, a document print function, a copy function, a photograph print function, and the like. On each of the images G, a symbol indicating a corresponding menu is displayed. It is possible for a user to scroll the images G by swiping or flicking the plurality of images G in the X-direction. In this regard, “swipe” refers to an operation to slide a finger on the touch panel 14. Also, “flick” refers to an operation to quickly move a finger as sweeping on the touch panel 14.

Next, a description will be given of the inclination of the images G and the length ratio of the images G in the inclined state with reference to FIG. 5 and FIG. 6. FIG. 5 is an explanatory diagram of an upright image G0 and an inclined image G1. Here, an “upright image G0” refers to an image G that is not in an inclined state with respect to the display screen of the touch panel 14. Also, an “inclined image G1” refers to an image G in an inclined state with respect to the display screen of the touch panel 14. The upright image G0 is a rectangle, that is to say, a parallelogram having all of the four angles of 90 degrees. The length in the X-direction of the upright image G0 illustrated in FIG. 5 is “Lx0”, and the length in the Y-direction is “Ly0”. In this case, the length ratio of the upright image G0 is “Lx0/Ly0”. The “maximum length ratio” described above refers to the length ratio of the upright image G0.

On the other hand, the inclined image G1 is a parallelogram having none of the four angles of 90 degrees. Also, as illustrated in FIG. 5, the inclined image G1 is an image displayed as if the upright image G0 is rotated by angle θ with the Y-axis as center in the state in which the −X-direction side of the upright image G0 is on the Y-axis. The angle θ is a value where 0≤θ<90. In FIG. 5, the upright image G0 is rotated clockwise, but the inclined image G1 may be produced by rotating the upright image G0 counterclockwise. In the following description, the inclined image G1 displayed as if the upright image G0 is rotated by angle θ in this manner is simply referred to as an “image G at the inclination angle θ”. In this regard, the inclined image G1 illustrated in FIG. 5, the angle of the −X-direction and the +Y-direction, and the interior angle of the +X-direction and the −Y-direction becomes (90−θ) degrees, and the angle of the +X-direction and the +Y-direction, and the interior angle of the −X-direction and the −Y-direction becomes (90+θ) degrees.

FIG. 6 is an explanatory diagram of the length ratio of the inclined image G1. As illustrated in FIG. 6, assuming that the length in the X-direction of the inclined image G1 is “Lx1”, it is possible to express that the length in the X-direction, “Lx1”, is as “Lx1=Lx0·cos θ”. Also, assuming that the length in the Y-direction of the inclined image G1 is “Ly1”, it is possible to express that the length in the Y-direction, “Ly1”, is as “Ly1=Ly0+Lx0·sin θ”. Accordingly, the length ratio of the inclined image G1 becomes “Lx1/Ly1=Lx0·cos θ/(Ly0+Lx0·sin θ)”. In this regard, the length ratio of the inclined image G1 becomes lower than the length ratio of the upright image G0. Also, the length ratio of the inclined image G1 decreases as the inclination angle 9 increases. The “first length ratio” described above refers to the length ratio of the inclined image G1 having a predetermined inclination angle θ.

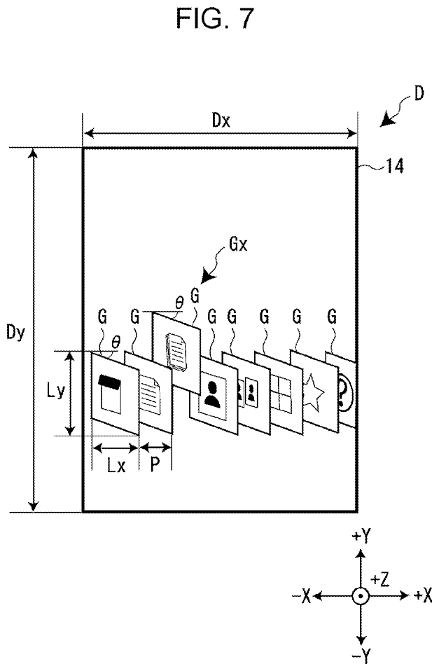

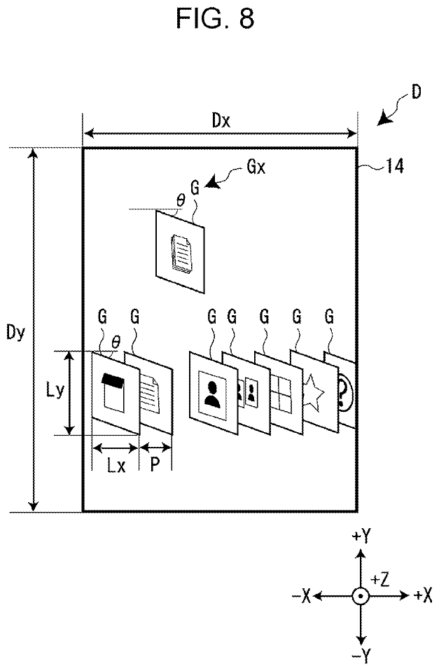

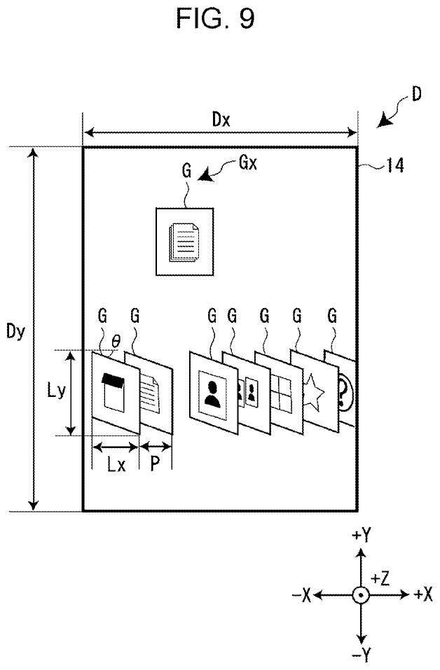

Next, a description will be given of the selection operation on the menu selection screen D with reference to FIG. 7 to FIG. 9. When any one of the images G is selected on the menu selection screen D illustrated in FIG. 4, the user terminal 1 displays animation in which the selected image G is pulled up and becomes an upright image. FIG. 7, FIG. 8, and FIG. 9 illustrate the screens during the animation display. Also, it is assumed that the selection operation illustrated in the following is performed when the size of the images G is smaller than or equal to the first size threshold value.

For example, in the menu selection screen D illustrated in FIG. 4, when a target image Gx, which is a third image G in the −X-direction, is selected, as illustrated in FIG. 7, the user terminal 1 slides the selected target image Gx in the +Y-direction and displays the image Gx. After a certain period of time from the display in FIG. 7, as illustrated in FIG. 8, the user terminal 1 slides the selected target image Gx further in the +Y-direction and displays the image Gx. Further, after a certain period of time from the display in FIG. 8, the user terminal 1 displays the selected target image Gx in an upright state as illustrated in FIG. 9. The display changing time from FIG. 7 to FIG. 8 and from FIG. 8 to FIG. 9 are about tens of milliseconds to hundreds of milliseconds.

In this regard, the target image Gx is displayed as the inclined image G1 (refer to FIG. 5) in FIG. 7 and FIG. 8. Also, the inclination angle of the target image Gx in this case is the same as the inclination angle of the other unselected images G. Also, the target image G x is displayed as the upright image G0 (refer to FIG. 5) in FIG. 9. In this case, the inclination angle of the target image Gx is “0 degrees”.

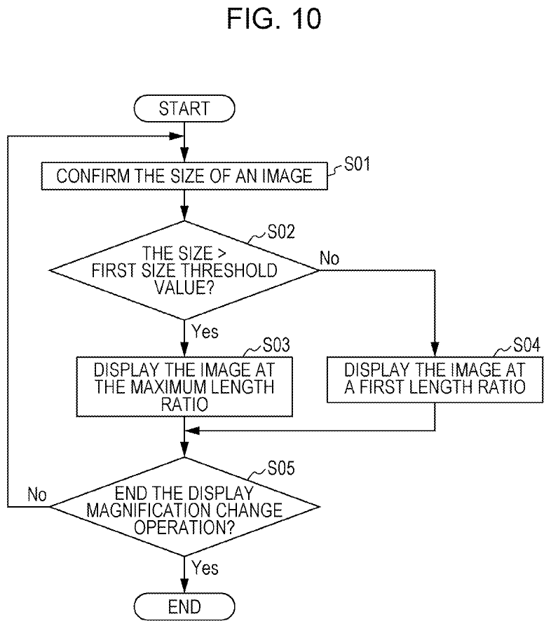

Next, a description will be given of the flow of display magnification change processing performed by the user terminal 1 with reference to a flowchart in FIG. 10. In this regard, the display magnification change processing is triggered by the start of an operation to change the display magnification of the images G. For example, when a change operation of the display magnification is performed by swiping out or swiping in, the user terminal 1 starts the display magnification change processing at the time when the start of moving two fingers is detected on the touch panel 14. In this regard, the display magnification change operation includes both an operation to increase the display magnification and an operation to decrease the display magnification.

In S01, the user terminal 1 confirms the size of an image G in the process of changing the display magnification. Here, the user terminal 1 confirms the length in the Y-direction of the image G as the size of the image G.

In S02, the user terminal 1 determines whether or not the size of an image G is larger than the first size threshold value. The first size threshold value is a threshold value of the length in the Y-direction of the image G. When the user terminal 1 determines that the size of the image G is larger than the first size threshold value, the processing proceeds to S03. Also, when the user terminal 1 determines that the size of the image G is not larger than the first size threshold value, the processing proceeds to S04.

In S03, the user terminal 1 displays the image G at the maximum length ratio. That is to say, the user terminal 1 displays the image G in the upright state.

In S04, the user terminal 1 displays the image G at a first length ratio. That is to say, the user terminal 1 displays the image G in an inclined state at a predetermined inclination angle θ.

In S05, the user terminal 1 determines whether or not the display magnification change operation has ended. For example, when an expansion or a shrink operation is performed by swiping out or swiping in, the user terminal 1 determines that the display magnification change operation has ended when the fingers have left the touch panel 14 after the swiping out or the swiping in operation. When the user terminal 1 determines that the display magnification change operation has ended, the user terminal 1 terminates the display magnification change processing. Also, when the user terminal 1 determines that the display magnification change operation has not ended, the processing returns to S01.

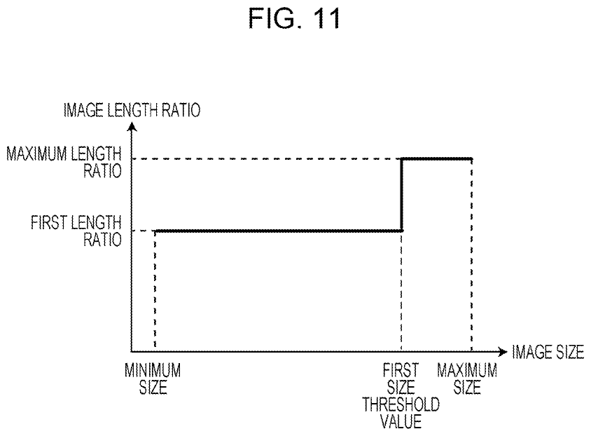

FIG. 11 is a graph illustrating the display magnification change processing according to the first embodiment. In the graph in FIG. 11, the horizontal axis represents the size of the image G, and the vertical axis represents the length ratio of the image G. For the size of the image G, a minimum size which becomes the minimum value and a maximum size which becomes the maximum value are determined in advance. The minimum size is the size of the image G when the image G has the minimum display magnification, and the maximum size is the size of the image G when the image G has the maximum display magnification.

As illustrated in FIG. 11, when the size of the image G is between the minimum size and the first size threshold value inclusive, the user terminal 1 sets the length ratio of the image G to the first length ratio. Also, when the size of the image G is larger than the first size threshold value and smaller than or equal to the maximum size, user terminal 1 sets the length ratio of the image G to the maximum length ratio.

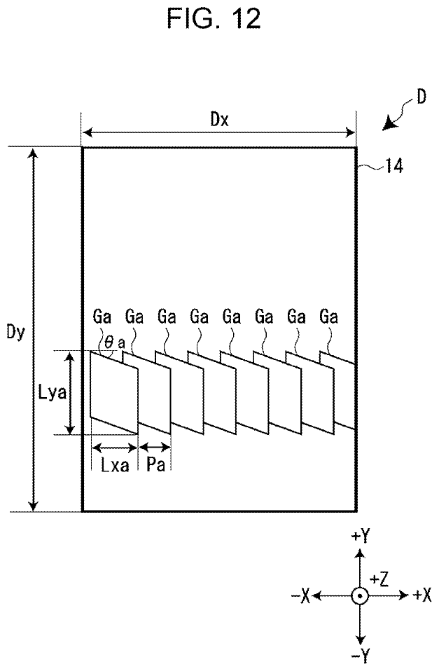

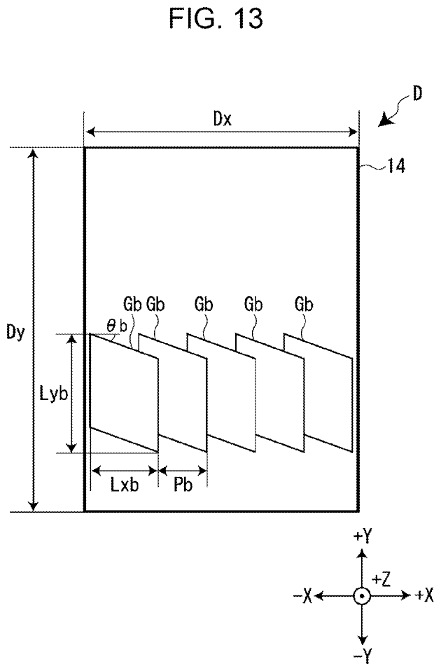

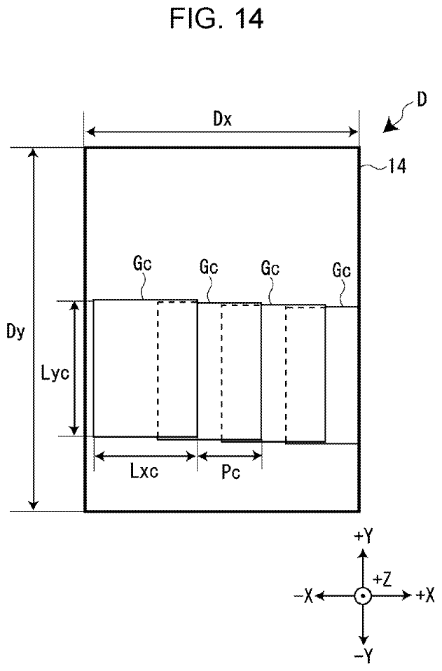

FIG. 12 to FIG. 14 are diagrams illustrating the display magnification change processing according to the first embodiment represented by the screen transition of the menu selection screen D. Here, a description will be given of the case when an operation to increase the display magnification of the image G is performed. Also, it is assumed that the image G illustrated in FIG. 12 and FIG. 13 have a size smaller than or equal to the first size threshold value, and the image G illustrated in FIG. 14 has a size larger than the first size threshold value. In this regard, in FIG. 12 and after that, the symbols illustrated in respective images G are omitted.

The length in the X-direction of an image Ga illustrated in FIG. 12 is “Lxa”, the length in the Y-direction is “Lya”, the disposition interval is “Pa”, and the inclination angle is “θa”. That is to say, the length ratio of the image Ga is “Lxa/Lya”, and the interval ratio of the image Ga is “Pa/Lxa”.

FIG. 13 illustrates a display example when the display magnification is increased from the state illustrated in FIG. 12. The length in the X-direction of an image Gb illustrated in FIG. 13 is “Lxb”, the length in the Y-direction is “Lyb”, the disposition interval is “Pb”, and the inclination angle is “θb”. The image Gb is produced by expanding the image Ga in FIG. 12, and thus “Lyb>Lya”. Also, the length ratio of the image Gb is “Lxb/Lyb”, the interval ratio of the image Gb is “Pb/Lxb”. In this regard, the image Gb has a size smaller than or equal to the first size threshold value. Accordingly, the length ratio “Lxb/Lyb”, the inclination angle “θb” and the interval ratio “Pb/Lxb” are the same as the length ratio of the image Ga, “Lxa/Lya”, in FIG. 12, the inclination angle “θa”, and the interval ratio “Pa/Lxa” respectively.

FIG. 14 illustrates a display example of the menu selection screen when an operation to increase the display magnification has been performed from the state illustrated in FIG. 13. The length in the X-direction of the images Gc illustrated in FIG. 14 is “Lxc”, the length in the Y-direction is “Lyc”, the disposition interval is “Pc”, and the inclination angle is “θc”. The images Gc are produced by expanding the images Gb in FIG. 13, and thus “Lyc>Lyb”. Also, the length ratio of the images Gc is “Lxc/Lyc”, and the interval ratio of the images Gc is “Pc/Lxc”. Also, the images Gc are larger than the first size threshold value, and thus the length ratio of the images Gc becomes the maximum length ratio, and the inclination angle of the images Gc become “0 degrees”. In this regard, the interval ratio of the images Gc, “Pc/Lxc”, is the same as the interval ratio of the images Ga in FIG. 12, “Pa/Lxa”, and the interval ratio of the image Gb in FIG. 13, “Pb/Lxb”.

In this regard, a plurality of images Gc are displayed by being slightly shifted in the Y-direction in FIG. 14. However, a plurality of images Gc may be displayed in a lined up state along the X-direction.

As described above, it is possible for the user terminal 1 according to the first embodiment to change the length ratio of a plurality of images G in accordance with the display magnification of the images G. Also, it is possible for the user terminal 1 to increase the length ratio when the size of the images G is larger than the first size threshold value than the length ratio when the size of the images G is smaller than or equal to the first size threshold value. In this manner, for example, when a user wants to gaze at the images G, the user performs an operation to increase the display magnification, and thus the images G are displayed enlarged in an upright state. Accordingly, it is possible for the user to confirm the information displayed on the images G in detail. On the contrary, when a user wants, for example, to search for a target image G from an image group, the user performs an operation to decrease the display magnification, and thus the images G are displayed reduced in an inclined state. Accordingly, it becomes easy for the user to make a confirmation by glancing a large number of images G.

In this regard, it is possible to employ the following variations in the first embodiment.

Variation 1.1

In the first embodiment, the user terminal 1 determines the length ratio of the images G based on the size of the images G. However, the user terminal 1 may determine the length ratio of the images G based on not the size of the images G but based on the ratio of the size of the images G to the screen size of the menu selection screen D. The “ratio of the size of the images G to the screen size of the menu selection screen D” may be any one of the length ratio in the X-direction “Lx/Dx”, the length ratio in the Y-direction “Ly/Dy”, and the area ratio “Lx·Ly/Dx·Dy”. For example, when an operation to increase the display magnification of the images G is performed, at the time when the ratio of the size of the images G to the screen size of the menu selection screen D becomes higher than a predetermined threshold value, the user terminal 1 may change the length ratio of the images G from the first length ratio to the maximum length ratio.

Variation 1.2

Also, as a further variation, the user terminal 1 may determine the length ratio of the images G based on the ratio of the size of the image G to the display screen size of the touch panel 14.

Variation 1.3

Also, as a further variation, the user terminal 1 may determine the length ratio of the images G based on the size of the symbol or the character displayed on the images G. The “size of the symbol or the character” may be any one of the length in the X-direction of the symbol or the character, the length in the Y-direction, and the occupied area. For example, when an operation to increase the display magnification of the images G is performed, at the time when the size of the symbol or the character displayed on the images G becomes larger than a predetermined threshold value, the user terminal 1 may change the length ratio of the images G from the first length ratio to the maximum length ratio.

Variation 1.4

Also, as a further variation, the user terminal 1 may determine the length ratio of the images G based on the ratio of the size of the symbol or the character to the display screen size of the touch panel 14 or the screen size of the menu selection screen D.

Variation 1.5

Also, as a further variation, the user terminal 1 may determine the length ratio of the images G based on the display magnification directly specified by the user.

Variation 1.6

When an operation to increase the display magnification of the images G is performed, the user terminal 1 may expand the images G and change the length ratio regardless of the display magnification of the images G and the size of the images G. For example, when an operation to increase the display magnification of the images G is not performed, the user terminal 1 may display the images G at a first length ratio, and when an operation to increase the display magnification of the images G is performed, the user terminal 1 may display the images G at a second length ratio which is higher than the first length ratio. Also, in this case, the second length ratio may be the maximum length ratio.

Variation 1.7

The user terminal 1 may change the interval ratio of the images G in accordance with the display magnification of the images G. For example, the user terminal 1 may increase the interval ratio when the size of the images G is larger than the first size threshold value from the interval ratio when the size of the image G is smaller than or equal to the first size threshold value.

### Second Embodiment

Next, a description will be given of a second embodiment of the present disclosure. In the first embodiment, the length ratio of the images G is changed in accordance with the display magnification of the images G in two stages. However, in the present embodiment, the length ratio of the images G is gradually changed in accordance with a change of the display magnification. In the following, a description will be given of different points from those in the first embodiment. Also, in the present embodiment, the same reference numeral is given to the same component as that in the first embodiment, and the detailed description will be omitted. Also, a variation that is applied to a component in the first embodiment is also applied to the equivalent component in the present embodiment in the same manner.

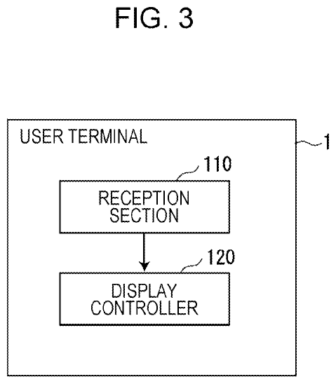

The functional configuration of the user terminal 1 according to the present embodiment is the same as the functional configuration (refer to FIG. 3) of the user terminal 1 according to the first embodiment. However, in the display controller 120 according to the present embodiment, when the reception section 110 receives specification to gradually change the display magnification, a plurality of images G are displayed on the touch panel 14 such that the display magnification of the images G and the length ratio of the images G are gradually changed in accordance with the specification.

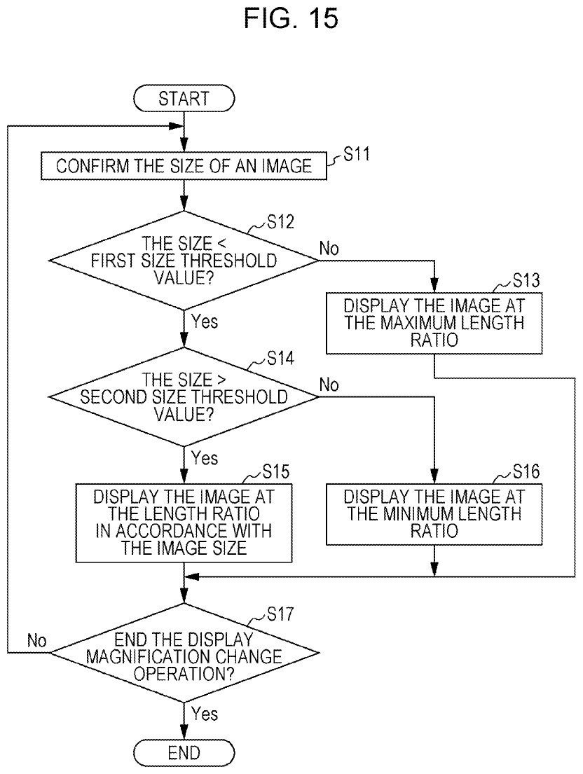

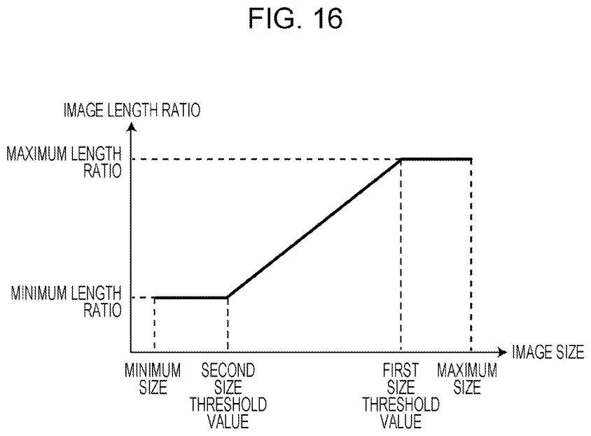

FIG. 15 is a flowchart illustrating the flow of the display magnification change processing according to the second embodiment. In the present embodiment, it is also assumed that expand and shrink operations are performed by swiping out and swiping in operations respectively.

In S11, the user terminal 1 confirms the size of an image G. For the size of the image G, for example, the user terminal 1 confirms the length in the Y-direction of the image G.

In S12, the user terminal 1 determines whether or not the size of the image G is smaller than the first size threshold value. The first size threshold value is a threshold value of the length in the Y-direction of the image G. When the user terminal 1 determines that the size of the image G is smaller than the first size threshold value, the processing proceeds to S14. Also, when the user terminal 1 determines that the size of the image G is not smaller than the first size threshold value, the processing proceeds to S13.

In S13, the user terminal 1 displays the image G at the maximum length ratio. That is to say, the user terminal 1 displays the image G in the upright state.

In S14, the user terminal 1 determines whether or not the size of the images G is larger than a second size threshold value. The second size threshold value is a predetermined threshold value, and is smaller than the first size threshold value and larger than the minimum size. When the user terminal 1 determines that the size of the image G is larger than the second size threshold value, the processing proceeds to S15. Also, when the user terminal 1 determines that the size of the images G is not larger than the second size threshold value, the processing proceeds to S16.

In S15, the user terminal 1 displays the image G at the length ratio in accordance with the size of the image G. In the present embodiment, “displays the image G at the length ratio in accordance with the size of the image G” refers to that the length ratio of the images G gradually increases as the size of the image G increases.

In S16, the user terminal 1 displays the images G at the minimum length ratio. That is to say, the user terminal 1 displays the image G in an inclined state so as to have the maximum inclination angle θ.

In S17, the user terminal 1 determines whether or not the display magnification change operation has ended. When the user terminal 1 determines that the display magnification change operation has ended, the user terminal 1 terminates the display magnification change processing. Also, when the user terminal 1 determines that the display magnification change operation has not ended, the processing returns to S11.

FIG. 16 is a graph illustrating the display magnification change processing according to the second embodiment. As illustrated in FIG. 16, when the size of the image G is equal to or larger than the minimum size and smaller than or equal to the second size threshold value, the user terminal 1 sets the length ratio of the images G to the minimum length ratio. Also, when the size of the images G is larger than the second size threshold value and smaller than or equal to the first size threshold value, the user terminal 1 linearly increases the length ratio of the images as the size of the images G increases. Also, when the size of the images G is larger than the first size threshold value and smaller than or equal to the maximum size, the user terminal 1 sets the length ratio of the images G to the maximum length ratio.

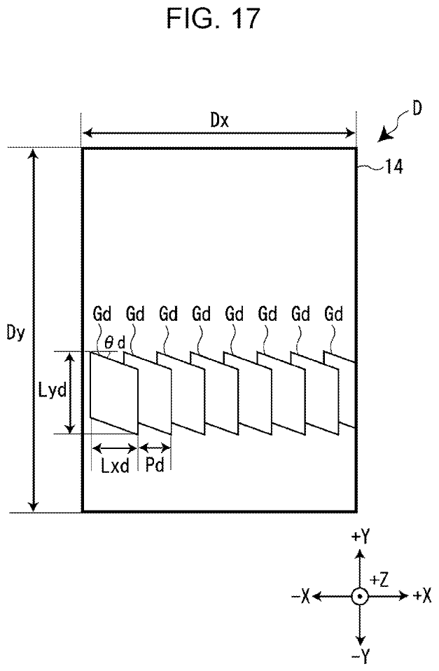

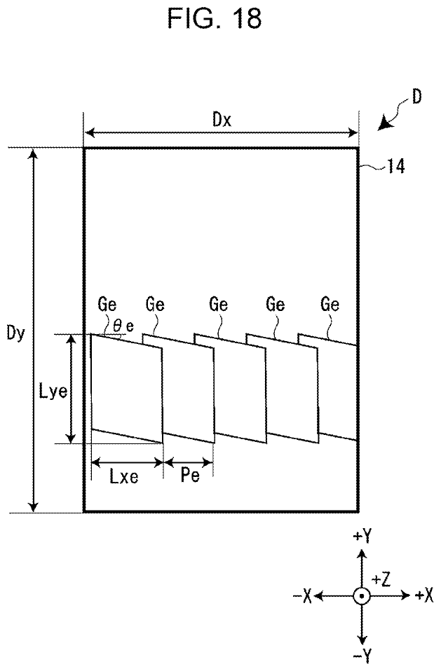

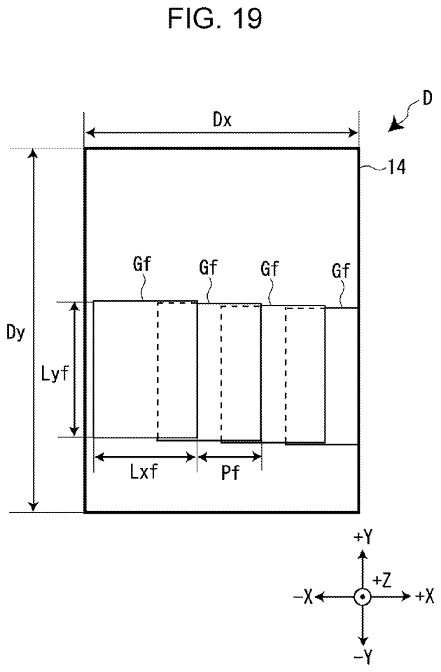

FIG. 17 to FIG. 19 are diagrams expressing the display magnification change processing according to the second embodiment represented by screen transition diagrams of the menu selection screen D. Here, a description will be given of the case when an operation to increase the display magnification of the touch panel 14 is performed. In this regard, it is assumed that the images G illustrated in FIG. 17 and FIG. 18 have the size larger than the second size threshold value and smaller than or equal to the first size threshold value. It is assumed that the images G illustrated in FIG. 19 have a size larger than the first size threshold value.

The length in the X-direction of the images Gd illustrated in FIG. 17 is “Lxd”, the length in the Y-direction is “Lyd”, the disposition interval is “Pd”, and the inclination angle is “Od”. That is to say, the length ratio of the images Gd is “Lxd/Lyd”, and the interval ratio of the images Gd is “Pd/Lxd”.

FIG. 18 illustrates a display example when the display magnification is increased from the state illustrated in FIG. 17. The length in the X-direction of the images Ge illustrated in FIG. 18 is “Lxe”, the length in the Y-direction is “Lye”, the disposition interval is “Pe”, and the inclination angle is “θe”. The images Ge are produced by expanding the images Gd illustrated in FIG. 17, and thus “Lye>Lyd”. Also, the length ratio of the images Ge is “Lxe/Lye”, and the interval ratio of the images Ge is “Pe/Lxe”. Also, the length ratio of the images Ge, “Lxe/Lye”, is higher than the length ratio of the images Gd, “Lxd/Lyd”, illustrated in FIG. 17, and the inclination angle “θe” of the images Ge is smaller than the inclination angle of the images Gd, “θd”, illustrated in FIG. 17. However, the interval ratio of the image Ge, “Pe/Lxe” is the same as the interval ratio of the images Gd, “Pd/Lxd”, illustrated in FIG. 17.

FIG. 19 illustrates a display example when the display magnification is increased from the state illustrated in FIG. 18. The length in the X-direction of the images Gf illustrated in FIG. 19 is “Lxf”, the length in the Y-direction is “Lyf”, and the disposition interval is “Pf”. The images Gf are produced by expanding the images Ge illustrated in FIG. 18, and thus “Lyf>Lye”. Also, the length ratio of the images Gf is “Lxf/Lyf”, and the interval ratio of the images Gf is “Pf/Lxf”. Also, the images Gf have a size larger than the first size threshold value, and thus the length ratio of the images Gf, “Lxf/Lyf”, becomes the maximum length ratio, and the inclination angle, “θf”, becomes “0 degrees”. Also, the interval ratio of the images Gf, “Pf/Lxf”, is the same as the interval ratio of the images Gd, “Pd/Lxd”, illustrated in FIG. 17 and the interval ratio of the images Ge, “Pe/Lxe”, illustrated in FIG. 18.

As described above, when the user terminal 1 according to the second embodiment receives specification to gradually change the display magnification of the images G, it is possible for the user terminal 1 to display a plurality of images G such that the display magnification of the images G and the length ratio of the images G gradually change in accordance with the specification.

In this regard, it is possible to employ the following variations in the second embodiment.

Variation 2.1

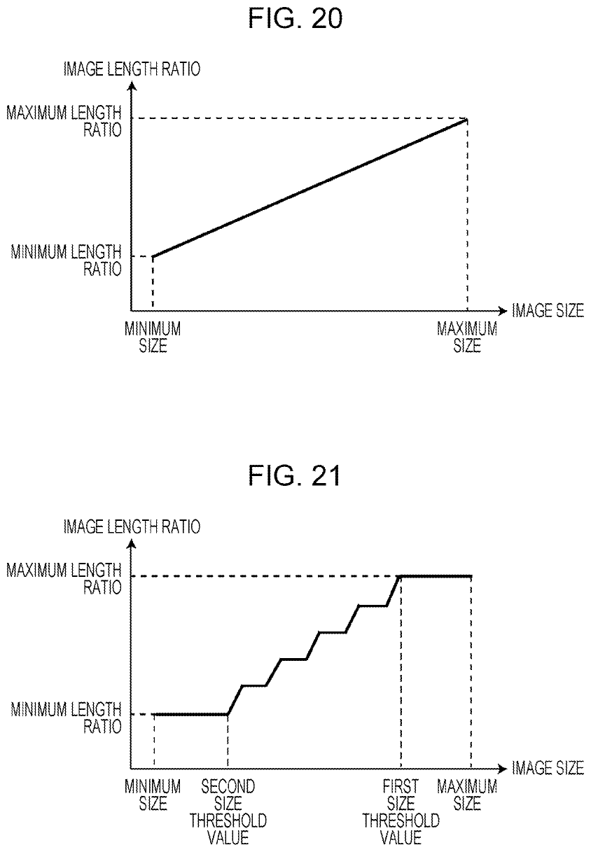

In the second embodiment, when the size of the images G is larger than the second size threshold value and smaller than or equal to the first size threshold value, the user terminal 1 linearly increases the length ratio of the images G as the size of the images G increases (refer to FIG. 16). However, as illustrated in FIG. 20, the user terminal 1 may linearly increase the length ratio of the images G as the size of the images G increases while the size of the images G is between the minimum size and the maximum size inclusive.

Variation 2.2

Also, as a further variation, while the size of the images G is larger than the second size threshold value and smaller than or equal to the first size threshold value, the user terminal 1 may increase the length ratio of the images G in a stair-like manner as illustrated in FIG. 21.

Variation 2.3

In the second embodiment, the user terminal 1 keeps the interval ratio of the images G constant regardless of the display magnification of the images G. However, the user terminal 1 may change the interval ratio of the images G in accordance with the display magnification of the images G.

The display controller 120 according to the present variation changes the interval ratio, which is the ratio of the disposition interval of a plurality of images G to the length in the X-direction of the images G, in accordance with the specified display magnification received by the reception section 110. More specifically, compared with the interval ratio when the first display magnification is specified, the display controller 120 increases the interval ratio when the second display magnification, which is higher than the first display magnification, is specified.

Also, compared with the change amount of the length ratio of the images G in accordance with the display magnification of the images G, the display controller 120 increases the change amount of the interval ratio of images G in accordance with the display magnification.

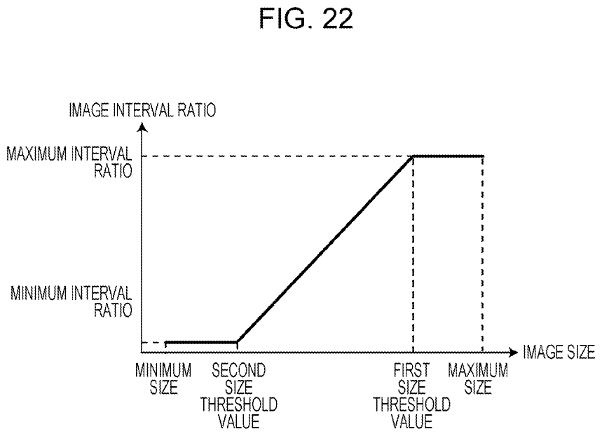

In the following, a description will be given of the present variation with reference to FIG. 22 to FIG. 25. FIG. 22 is a graph illustrating the relationship between the size of the images G and the interval ratio of the images G. As illustrated in FIG. 22, when the size of the images G is equal to or larger than the minimum size and smaller than or equal to the second size threshold value, the user terminal 1 sets the interval ratio of the images G to the minimum interval ratio, which is the minimum value of the interval ratio. Also, when the size of the images G is larger than the second size threshold value and smaller than or equal to the first size threshold value, the user terminal 1 linearly increases the interval ratio of the images G as the size of the images G increases. Also, when the size of the images G is larger than the first size threshold value, the user terminal 1 sets the interval ratio of the images G to the maximum interval ratio, which is the maximum value of the interval ratio.

In this regard, in the present variation, the relationship between the size of the images G and the length ratio of the images G is as illustrated in FIG. 16. The user terminal 1 makes the difference between the minimum interval ratio and the maximum interval ratio in FIG. 22 larger than the difference between the minimum length ratio and the maximum length ratio in FIG. 16. Thereby, it is possible for the user terminal 1 to make the change amount of the interval ratio of the images G in accordance with the display magnification of the images G larger than the change amount of the length ratio of the images G in accordance with the display magnification of the images G.

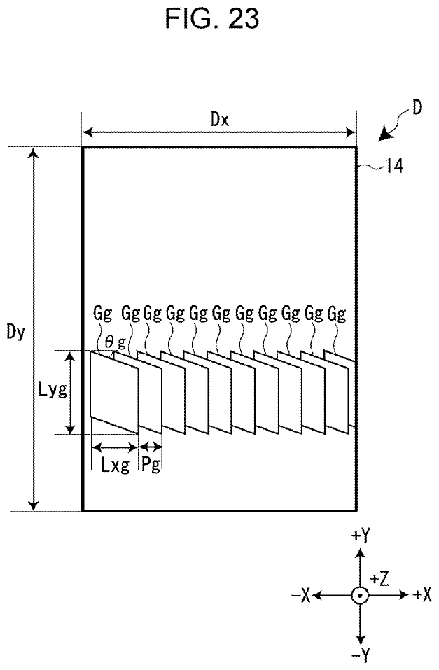

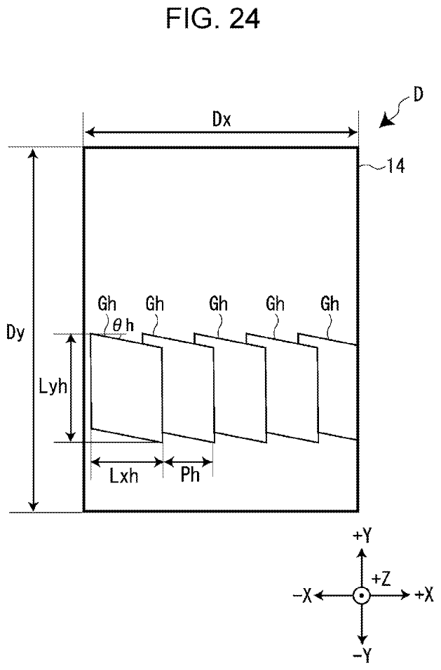

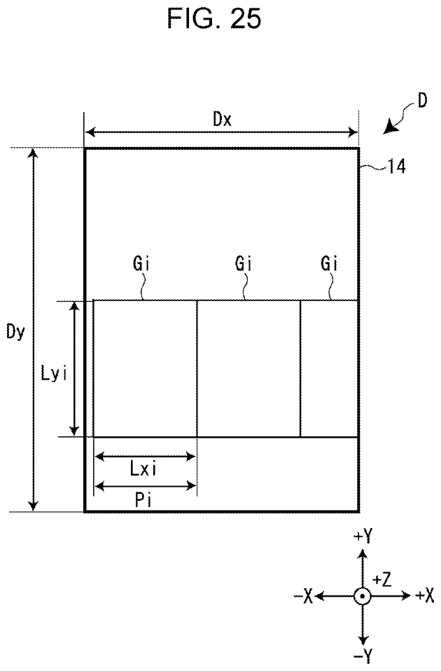

FIG. 23 to FIG. 25 are diagrams of the display magnification change processing according to the present variation represented by the screen transition diagrams of the menu selection screen D. Here, it is assumed that an operation to increase the display magnification of the images G is performed. In this regard, the images G illustrated in FIG. 23 and FIG. 24 have a size larger than the second size threshold value and smaller or equal to the first size threshold value. The images G illustrated in FIG. 25 have a size larger than the first size threshold value.

The length in the X-direction of the images Gg illustrated in FIG. 23 is “Lxg”, the length in the Y-direction is “Lyg”, the disposition interval is “Pg”, and the inclination angle is “θg”. That is to say, the length ratio of the images Gg is “Lxg/Lyg”, the interval ratio of the images Gd is “Pg/Lxg”, and the inclination angle is “θg”.

FIG. 24 illustrates a display example when the display magnification is increased from the state illustrated in FIG. 23. The length in the X-direction of the images Gh illustrated in FIG. 24 is “Lxh”, the length in the Y-direction is “Lyh”, the disposition interval is “Ph”, and the inclination angle is “θh”. The images Gh are produced by expanding the images Gg in FIG. 23, and thus “Lyh>Lyg”. Also, the length ratio of the images Gh is “Lxh/Lyh”, and the interval ratio of the images G is “Ph/Lxh”. Also, the length ratio of the images Gh, “Lxh/Lyh”, is higher than the length ratio of the images Gg, “Lxg/Lyg”, in FIG. 23. Also, the inclination angle of the images Gh, “θh”, is smaller than the inclination angle of the images Gg, “θg”, in FIG. 23. Also, the interval ratio of the images Gh, “Ph/Lxh”, is higher than the interval ratio of the images Gg, “Pg/Lxg”, in FIG. 23.

FIG. 25 is a display example when the display magnification is increased from the state illustrated in FIG. 24. The length in the X-direction of the images Gi illustrated in FIG. 25 is “Lxi”, the length in the Y-direction is “Lyi”, and the disposition interval is “Pi”. The images Gi are produced by expanding the images Gh in FIG. 24, and thus “Lyi>Lyh”. Also, the length ratio of the images Gi is “Lxi/Lyi”, and the interval ratio of the images Gi is “Pi/Lxi”. Also, the images Gi have a size larger than the first size threshold value, and thus the length ratio of the images Gi, “Lxi/Lyi” becomes the maximum length ratio, and the inclination angle, “θi”, becomes “0 degrees”. Also, the interval ratio of the images Gi, “Pi/Lxi”, becomes the maximum interval ratio. In this regard, in FIG. 25, “Lxi=Pi”, and the maximum interval ratio is illustrated as 100%.

As described above, it is possible for the user terminal 1 according to the variation 2.3 to change the interval ratio of the images G in accordance with the display magnification of the images G. Also, the user terminal 1 makes the interval ratio when the second display magnification, which is higher than the first display magnification, is specified higher than the interval ratio when the first display magnification is specified, and thus compared with the case of keeping the interval ratio constant, it is possible to improve the easiness of viewing the individual images G when the display magnification is increased. Further, the user terminal 1 makes the change amount of the interval ratio in accordance with the display magnification larger than the change amount of the length ratio in accordance with the display magnification, and thus it is possible to improve easiness of viewing the individual images G when the display magnification is increased.

In this regard, the plurality of images G are not necessarily have the same size and the same interval ratio. Also, the user terminal 1 does not have to linearly increase the interval ratio of the images G as the size of images G increases while the size of the images G is larger than the second size threshold value and smaller than or equal to the first size threshold value as illustrated in FIG. 22. The user terminal 1 may linearly increase the interval ratio of the images G as the size of the images G increases while the size of the images G is between the minimum size and the maximum size inclusive.

Also, the user terminal 1 makes the change amount of the interval ratio in accordance with the display magnification larger than the change amount of the length ratio in accordance with the display magnification. However, it may be possible to compare the change ratio instead to the change amount. That is to say, the user terminal 1 may makes the change ratio of the interval ratio of the images G in accordance with the display magnification of the images G larger than the change ratio of the length ratio of the images G in accordance with the display magnification of the images G.

Variation 2.4

The user terminal 1 increases the length ratio of the images G as the display magnification of the images G increases. However, when a magnification change speed, which is a speed to increase the display magnification by a user, becomes higher than a predetermined threshold value, the length ratio of the images G may be set to the maximum length ratio. On the contrary, the user terminal 1 decreases the length ratio of the images G as the display magnification of the images G decreases. However, when the magnification change speed becomes lower than or equal to a predetermined threshold value, the user terminal 1 may set the length ratio of the images G to the minimum length ratio.

In the above, the two embodiments are described, but it is possible to employ the following variations in the both embodiments in common. In this regard, it is possible to suitably combine each of the embodiments and each of the variations with the following variations.

Variation 3.1

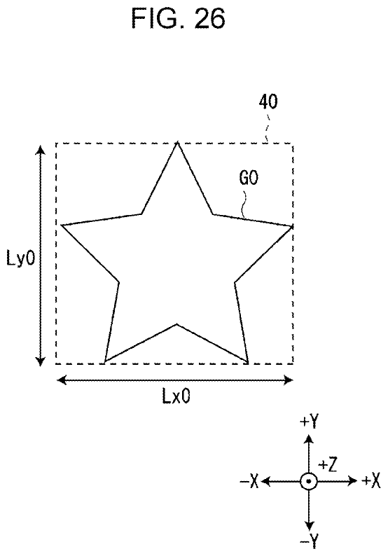

In each of the embodiments described above, it is assumed that the images G are quadrilaterals, but the images may have shapes other than quadrilaterals. For example, as illustrated in FIG. 26, the images G may be star-shaped. In this case, it is possible to express the size of an upright image G0 by the size of a circumscribed rectangle 40 circumscribed about the upright image G0. That is to say, in the example in FIG. 26, the length in the X-direction of the upright image G0 is “Lx0”, the length in the Y-direction of the image G0 is “Ly0”, and the length ratio is “Lx0/Ly0”. Also, in this case, it is possible to obtain an inclined image G1 by inclining the circumscribed rectangle 40 by the same method as that of the embodiments described above.

Variation 3.2

In each of the embodiments described above, a plurality of images G are displayed on the menu selection screen D. However, any type of the screens on which a plurality of images G are displayed may be used. Also, a plurality of images G may be arranged vertically or diagonally in line, or lined up on a curve. Further, the images G may be arranged in multiple rows. Also, the display magnification may not be specified on the entire touch panel 14. The display magnification may be specified on a specific operation screen, such as the menu selection screen D, and the like, that is to say, on a specific window. Also, the images G may represent information other than menus. For example, the images G may represent pages of an electronic book or photographs in an electronic album.

Variation 3.3

In each of the embodiments described above, the user terminal 1 makes the length ratio of the images G when the second display magnification, which is higher than the first display magnification, is specified higher than the length ratio of the images G when the first display magnification is specified. However, the opposite may be applied. That is to say, the user terminal 1 may make the length ratio of the images G when the second display magnification is specified lower than the length ratio of the images G when the first display magnification is specified.

Variation 3.4

In each of the embodiments described above, the user terminal 1 makes the interval ratio of the images G when the second display magnification, which is higher than the first display magnification, is specified larger than the interval ratio of the images G when the first display magnification is specified. However, the opposite may be applied. That is to say, the user terminal 1 may make the interval ratio of the images G when the second display magnification is specified smaller than the interval ratio of the images G when the first display magnification is specified.

Variation 3.5

In the variation 2.3 described above, the user terminal 1 makes the change amount of the interval ratio in accordance with the display magnification larger than the change amount of the length ratio in accordance with the display magnification. However, the opposite may be applied. That is to say, the user terminal 1 may make the change amount of the interval ratio in accordance with the display magnification smaller than the change amount of the length ratio in accordance with the display magnification. Also, when expressing the relationship between the three variables, namely, the display magnification, the change amount of the length ratio, and the change amount of the interval ratio by a graph, the graph may be linear, stair-like, or parabolic. Also, it is possible to employ any shape.

Variation 3.6

Also, the maximum interval ratio, which is the maximum value of the interval ratio, may be a value less than 100% or a value higher than 100% instead of 100%.

Variation 3.7

The “change in the length ratio of the images G” in the embodiment described above may be read as the “inclination rate of the images G with respect to the touch panel 14”. Here, as illustrated in FIG. 5, and the like, the “inclination rate” is a value determined by the inclination angle θ of the inclined images G1 produced such as by rotating the images G by angle θ with the Y-axis as center. That is to say, it is possible to express the “inclination rate” by “(θ/90)×100”%. Also, the images G having an inclination rate of “0%” is the upright image G0, and the images G having an inclination rate higher than “0%” and lower than “100%” is the inclined image G1. Further, the image G is not limited to an image produced by rotating by angle θ with the Y-axis as center. The images G may be displayed as if the image G is rotated by angle θ with the X-axis as center, or may be displayed as if the image G is rotated by angle θ with the other rotation axis as center. In particular, it is desirable to display the images G as if the image G is rotated by angle θ with an axis perpendicular to the direction in which images G are lined up as center. In this regard, assuming that the images G are rotated with the X-axis as center, the length ratio ought to be defined as “Ly0/Lx0”.

Variation 3.8

In the embodiments described above, no consideration is given to a depression angle, which is an angle looking down the images G from above. However, the length in the X-direction and the length in the Y-direction of the inclined images G1 may be determined in consideration of a change in the depression angle. A depression angle increases as the inclination angle θ of the images G increases. When the images G are upright, the images G are in the state of being viewed from the +Z-direction, and thus the depression angle becomes “0 degrees”. In this case, assuming that the depression angle is “ϕ”, the length in the X-direction of the inclined images G1 is “Lx1=Lx0·cos θ”, and the length in the Y-direction of the inclined image G1 is “Ly1=Ly0·cos ϕ+Lx0·sin θ·sin ϕ”.

Variation 3.9

The screen on which the images G are displayed does not have to be the touch panel 14. For example, the images G are displayed on a display, and specification of the display magnification and a selection operation of an image G may be performed by using an operation device disposed separately from the display. Also, in this case, the display magnification may be specified by using a device that is able to adjust an output value by moving a physical operator, such as a fader device, or the like. In addition, specification of the display magnification and a selection operation of an image G may be performed by an operation using voice or eye tracking.

Variation 3.10

In the embodiments described above, the images G are inclined so as to change the length ratio of the images G. However, the length ratio of the images G may be changed while the images G are displayed in an upright state.

Variation 3.11

The electronic device controlled by the user terminal 1 may be a device other than the complex machine 2. As the electronic device, a printer, a scanner, a projector, a copy machine, and the like are considered. In addition, variations may be suitably made without departing from the spirit and scope of the disclosure.

### APPENDIXES

In the following, appendixes are given concerning the display device and the non-transitory computer-readable storage medium storing the program.

A display device for displaying an image G on a touch panel 14, the display device including: a reception section 110 configured to receive specification of a display magnification of the image G; and a display controller 120 configured to display the image G on the touch panel 14, wherein assuming that a length of the image G in a first direction of the touch panel 14 is Y, and a length of the image G in a second direction intersecting the first direction is X, the display controller 120 changes a length ratio being X/Y in accordance with the display magnification.

A non-transitory computer-readable storage medium storing a program for causing a display device to perform processing to display an image G on a touch panel 14 of a display device, the processing including: a receiving step of receiving specification of a display magnification of the image G; and a display controlling step of displaying the image G on the touch panel 14, wherein in the display controlling step, assuming that a length of the image G in a first direction of the touch panel 14 is Y, and a length of the image G in a second direction intersecting the first direction is X, a length ratio being X/Y is changed in accordance with the display magnification.

With this configuration, it is possible for the display device to change the length ratio, which is the ratio of the length in the second direction intersecting the first direction to the length of the image G in the first direction of touch panel 14 in accordance with the specified display magnification.

In the display device described above, the display controller 120 displays a plurality of the images G side by side in the second direction, and compared with the length ratio when a first one of the display magnification is specified, the display controller 120 may increase the length ratio when a second one of the display magnification being higher than the first one of the display magnification is specified.

With this configuration, when the display device displays a plurality of images G side by side in the second direction, it is possible for the display device to make the length ratio when the second display magnification is specified larger than the length ratio when the first display magnification is specified.

In the display device described above, the display controller 120 may display a plurality of the images at the display magnification in a plurality of stages on the touch panel 14, and may display the plurality of the images G on the touch panel 14 so as to have the length ratio being different in accordance with the stages of the display magnification.

With this configuration, it is possible for the display device to change the length ratio of the plurality of image G in stages in accordance with the specified stage of the display magnification.

In the display device described above, the display controller 120 may display a plurality of the images G on the touch panel 14 by gradually changing the display magnification, and may display the plurality of the images on the touch panel 14 such that the display magnification and the length ratio gradually change in accordance with a change in the display magnification.

With this configuration, it is possible for the display device to gradually change the display magnification and the length ratio of the plurality of images G in accordance with specification of gradual change in the display magnification.

In the display device described above, assuming that a disposition interval of the two adjacent images in the second direction is P, the display controller 120 may change an interval ratio being P/X in accordance with the display magnification.

With this configuration, assuming that a disposition interval of the two adjacent images in the second direction is P, it may be possible for the display device to change an interval ratio being P/X in accordance with the display magnification.

In the display device described above, compared with the interval ratio at a time of the first one of the display magnification, the display controller 120 may increase the interval ratio at a time of the second one of the display magnification.

With this configuration, it is possible for the display device to make the interval ratio at a time of the second display magnification larger than the interval ratio at a time of the first display magnification.

In the display device described above, the display controller 120 may make a change amount of the interval ratio in accordance with the display magnification larger than a change amount of the length ratio in accordance with the display magnification.

With this configuration, it is possible for the display device to may make a change amount of the interval ratio in accordance with the display magnification larger than a change amount of the length ratio in accordance with the display magnification.

A display device for displaying an image G on a touch panel 14, the display device including: a reception section 110 configured to receive specification of a display magnification of the image G; and a display controller 120 configured to display the image G in an inclined manner at a predetermined inclination rate with respect to the touch panel 14, wherein the display controller 120 changes the inclination rate in accordance with the display magnification.

A non-transitory computer-readable storage medium storing a program for causing a display device to perform processing to display an image G on a touch panel 14 of a display device, the processing including: a receiving step of receiving specification of a display magnification of the image G; and a display controlling step of displaying the image G in an inclined manner at a predetermined inclination rate with respect to the touch panel 14, wherein in the display controlling step, the inclination rate is changed in accordance with the display magnification.

With this configuration, it is possible for the display device to change the inclination rate of the image G with respect to the touch panel 14 in accordance with the specified display magnification. In this regard, a predetermined inclination rate does not refer to a constant inclination rate, but refers to an unspecified inclination rate, such as a “certain inclination rate”.

What is claimed is:

1. A display device for displaying an image on a screen, the display device comprising:
a reception section configured to receive specification of a display magnification of the image; and
a display controller configured to display the image on the screen, wherein
assuming that a length of the image in a first direction of the screen is Y, and a length of the image in a second direction intersecting the first direction is X, the display controller changes a length ratio being X/Y in accordance with the display magnification.

2. The display device according to claim 1, wherein
the display controller displays a plurality of the images side by side in the second direction, and
compared with the length ratio when a first one of the display magnification is specified, the display controller increases the length ratio when a second one of the display magnification being higher than the first one of the display magnification is specified.

3. The display device according to claim 2, wherein
the display controller displays a plurality of the images at a plurality of stages of the display magnification on the screen, and
displays the plurality of the images on the screen so as to have the length ratio being different in accordance with the stages of the display magnification.

4. The display device according to claim 3, wherein
the display controller displays a plurality of the images on the screen by gradually changing the display magnification, and
displays a plurality of the images on the screen such that the display magnification and the length ratio gradually change in accordance with a change of the display magnification.

5. The display device according to claim 2, wherein
assuming that a disposition interval of two of the adjacent images in the second direction is P, the display controller changes an interval ratio being P/X in accordance with the display magnification.

6. The display device according to claim 5, wherein
compared with the interval ratio at a time of the first one of the display magnification, the display controller increases the interval ratio at a time of the second one of the display magnification.

7. The display device according to claim 6, wherein
compared with a change amount of the length ratio in accordance with the display magnification, the display controller increases a change amount of the interval ratio in accordance with the display magnification.

8. A non-transitory computer-readable storage medium storing a program for causing a display device to perform processing to display an image on a screen, the processing comprising:
a receiving step of receiving specification of a display magnification of the image; and
a display controlling step of displaying the image on the screen, wherein
in the display controlling step, assuming that a length of the image in a first direction of the screen is Y, and a length of the image in a second direction intersecting the first direction is X, a length ratio being X/Y is changed in accordance with the display magnification.

9. A non-transitory computer-readable storage medium storing a program for causing a display device to perform processing to display an image on a screen, the processing comprising:
a receiving step of receiving specification of a display magnification of the image; and
a display controlling step of displaying the image in an inclined manner at a predetermined inclination rate with respect to the screen, wherein
in the display controlling step, the inclination rate is changed in accordance with the display magnification.
